(19) United States
(12) Patent Application Publication
(10) Pub. No.: US 2005/0128902 A1
(43) Pub. Date: Jun. 16, 2005

(54) OPTICAL DISC SYSTEM AND ASSOCIATED TILT ANGLE CALIBRATION METHOD

(76) Inventor: Ming-Hsien Tsai, Kao-Hsiung City (TW)

Correspondence Address: NORTH AMERICA INTERNATIONAL PATENT OFFICE (NAIPC), P.O. BOX 506, MERRIFIELD, VA, 22116, US

(21) Appl. No.: 10/707,395

(22) Filed: Dec. 10, 2003

(51) Int. Cl. G11B 7/095

(52) U.S. Cl. 369/44.32; 369/53.19

(57) ABSTRACT

A controllable tilt servo adjusts a tilt angle between an optical disc and an object lens according to a control signal from a CPU. An optical electric integrated circuit (OEIC) generates a differential phase detection (DPD) signal according to light received through the object lens from the optical disc. A tilt search block receives the DPD signal and controls the tilt servo by adjusting the tilt angle between the optical disc and the object lens according to the DPD signal. By iteratively scanning pluralities of tilt angles, each plurality of angles having decreasing angle differences and being centered on the tilt angle having the lowest amplitude DPD signal, an optimal tilt angle having the lowest amplitude DPD signal can be found.

### BACKGROUND OF INVENTION

1. Field of the Invention

The invention relates to an optical disc system, and more particularly, to an optical disc system capable of calibrating the tilt angle between an optical disc and an object lens.

2. Description of the Prior Art

Optical discs are well suited for storing large amounts of data and have a long lifetime. For these reasons, optical discs are widely used in today's ever increasingly computerized society. Optical discs do not suffer from magnetic deterioration over time as do magnetic media types. Compact discs (CDs), compact disc read only memories (CD-ROMs), digital versatile discs (DVDs), and various types of writable versions of these formats are all commonly used today. Although differing in physical form and digital format, in general, all optical disc systems project a beam of light on an optical disc through an object lens. This light is reflected off the optical disc and detected by an optical detector. Information is encoded on the optical disc using fine marks also referred to as pits that alter the reflected light. By detecting the different way the light reflects from these pits, the information encoded on the disc can be reproduced by the optical disc system.

When reproducing information from an optical disc, it is important to properly align the optical disc and the object lens. The light beam must be focused directly on tracks containing the pit marks, and the reflected light must be centered on the optical sensor. If the incident light beam on the surface of the optical disc is misaligned relative to the disc surface, it may be impossible for the optical sensor to accurately reproduce the encoded data. If the alignment is close but still incorrect, increased data errors and clock jitter in the received data stream will lower the quality of the optical disc system.

To ensure proper alignment, optical disc systems typically employ a tilt servo device for adjusting the tilt angle between the optical disc and the object lens. The tilt servo device maintains the incident light beam at an angle perpendicular to the surface of optical disc so that the reflected light is focused directly in the center of the optical receiver. In order to fulfill this task, the tilt servo device needs to include a tilt detection means for detecting a misalignment of the tilt angle so that the tilt servo device can make the appropriate correction. Two commonly used tilt detection means are the tilt sensor and the jitter meter.

The tilt sensor is normally used in conjunction with a separate beam of light, referred to herein as the tilt beam, which is similar to the beam of light used to read the data from the optical disc, referred to herein as the read beam. By reflecting the tilt beam off the optical disc onto a separate light sensing tilt sensor, the tilt angle between the optical disc and the object lens can be directly measured. The tilt beam/sensor pair and the read beam/sensor pair must physically be as close to each other as possible so that the tilt angle seen by the tilt sensor will accurately approximate the tilt angle seen by the read sensor. However, it is often difficult to perfectly align these two light beams. Using a separate light beam and sensor pair, which must themselves be properly aligned, to correct an alignment problem is not an optimal solution.

Another common solution to this tilt angle calibration problem involves the use of a jitter meter. Because the jitter of the recovered data stream increases as the optical disc and the object lens become misaligned, the tilt angle producing the least amount of jitter can be assumed to be the optimal alignment. A jitter meter can be included in the optical disc system, allowing the optical disc system to monitor the jitter of the received data stream and appropriately control the tilt servo device to adjust the tilt angle producing the least amount of jitter. However, using the jitter meter significantly increases the complexity of the design and requires extra components such as the jitter meter to be added to the optical disc system.

Fukumoto et al. in U.S. Pat. No. 6,493,296 disclose an optical disc inclination detecting method, an optical pickup device, and an optical disc system, which use a push pull system to solve the above mentioned tilt angle calibration problem. Their optical disc system uses a dividing unit to divide the read beam and form a main light spot and two side spots on the optical disc. Separate photo detectors are used to measure the light on the main spot and the two side spots. Signal generators are used to detect the tilt angle of the optical disc and control the tilt servo device to calibrate the tilt angle according to the output of the photo detectors. This optical disc system, however, again requires additional hardware components and increased design complexity, increasing the overall cost of the optical disc system. A need remains for a low cost solution to the tilt angle calibration problem.

### SUMMARY OF INVENTION

It is therefore a primary objective of the claimed invention to provide an optical disc system and method capable of calibrating the tilt angle between an optical disc and an object lens, to solve the above-mentioned tilt angle problem.

According to the claimed invention, an optical drive system is disclosed comprising an optical disc, an object lens for focusing light on the optical disc, a tilt servo for adjusting a tilt angle between the optical disc and the object lens, an optical electric integrated circuit (OEIC) for detecting light reflected from the optical disc, a DPD generator for generating a differential phase detection (DPD) signal according to the output of the OEIC, and a tilt search block receiving the DPD signal and being connected to the tilt servo. The tilt search block controls the tilt servo to adjust the tilt angle between the optical disc and the object lens according to the DPD signal.

Also according to the claimed invention, a method is disclosed for calibrating the tilt angle between an optical disc and an object lens in an optical storage device. The method comprises the following steps: (a) providing a tilt servo for adjusting the tilt angle between the optical disc and the object lens, (b) providing an optical electric integrated circuit (OEIC) for detecting light reflected from the optical disc, (c) generating a differential phase detection (DPD) signal according to the output of the OEIC, and (d) controlling the tilt servo to adjust the tilt angle between the optical disc and the object lens according to the DPD signal.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of an optical disc system according to the first embodiment of the present invention.

FIG. 2 is a block diagram showing the OEIC and the DPD signal generator of FIG. 1.

FIG. 3 is a graph of DPD signal amplitude vs. tilt angle.

FIG. 4 is a graph of DPD signal amplitude while searching for the optimal tilt angle using the DPD signal.

FIG. 5 is a block diagram of an optical disc system according to the second embodiment of the present invention.

FIG. 6 is a flowchart describing a method of calibrating the tilt angle of an optical disc system according to the present invention.

### DETAILED DESCRIPTION

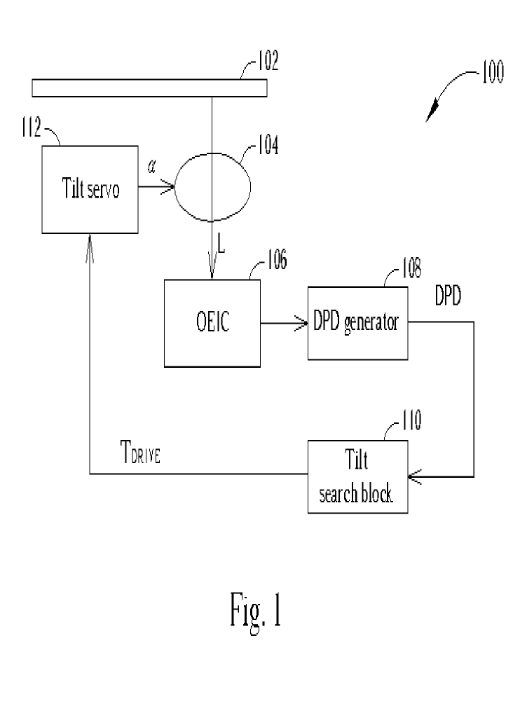

FIG. 1 shows a block diagram of an optical disc system 100 according to the first embodiment of the present invention. The optical disc system 100 comprises an optical disc 102, an object lens 104, an optical electrical integrated circuit (OEIC) 106, a differential phase detection (DPD) signal generator 108, a tilt search block 110, and a tilt servo 112. Incident light is reflected off the optical disc 102 at a tilt angle controlled by the tilt servo 112. The tilt servo 112 receives a control signal T_{DRIVE} from the tilt search block specifying a tilt angleα between the optical disc 102 and the object lens 104. The tilt servo 112 controls the tilt angleα. Reflected light L passes through the object lens and is detected by the OEIC 106. The OEIC 106 is an optical sensor that generates electrical signals according to the reflected light L. The DPD signal is a common signal required in optical disc systems and the DPD signal generator 108 generates this DPD signal according to the output of the OEIC 106. The tilt search block 110 uses the amplitude of the DPD signal to compare the accuracy of different tilt angles and determine an optimal tilt angle having the lowest amplitude DPD signal.

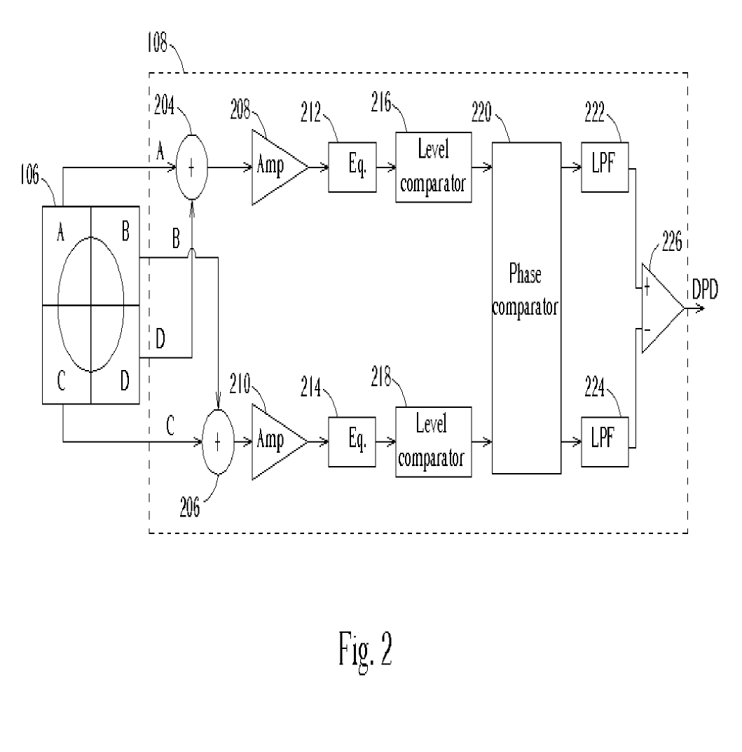

FIG. 2 shows a block diagram of the connection between the OEIC 106 and the DPD signal generator 108 of FIG. 1. The DPD signal generator 108 comprises first and second adders 204, 206; first and second amplifiers 208, 210; first and second equalizers 212, 214; first and second level comparators 216, 218; a phase comparator 220; first and second low-pass filters 222, 224; and a subtractor 226. The OEIC 106 is divided into four sensors A, B, C, D. The first adder 204 adds the output of the OEIC 106 for the A and D sensors. The output of the first adder 204 is amplified by the first amplifier 208, equalized by the first equalizer 212, level compared by the first level comparator 216, and then connected to the phase comparator 220. Similarly, the second adder 206 adds the output of the OEIC 106 for the C and B sensors. The output of the second adder 206 is amplified by the second amplifier 210, equalized by the second equalizer 214, level compared by the second level comparator 218, and also connected to the phase comparator 220. The phase comparator 220 compares the phase of the incoming signals and generates two pulse trains which are then low-pass filtered by the first low-pass filter 222 and the second low-pass filter 224 respectively. The subtractor 226 generates the DPD signal according to the difference between the output of the first and second low-pass filters 222, 224. It should be noted that alternative methods of generating the DPD signal are well known in the prior art and can also be used with the present invention. As the DPD signal is well known in the prior art, further description of its generation is hereby omitted.

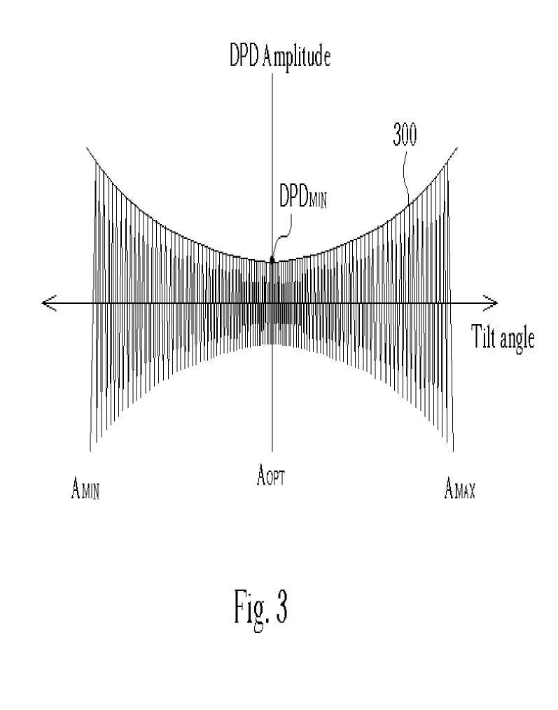

FIG. 3 shows a graph of DPD signal amplitude vs. tilt angle. As the tilt angle increases from a minimum angle of A_{MIN} to a maximum angle of A_{MAX}, the amplitude of the DPD signal dips to a minimum level DPD_{MIN} at the optimal tilt angle A_{OPT}. This property can be used to determine the optimal tilt angle directly using the DPD signal. A measurement such of the amplitude of the DPD signal such as a peak-to-peak measurement or the DPD signal envelope 300 shown in FIG. 3 can be used to track the amplitude of the DPD signal. Using the DPD signal to determine the optimal tilt angle is more accurate than the tilt sensor used in the prior art because the DPD signal directly corresponds to the light received at the OEIC 106. As the output of the OEIC is used to decode the data, it is therefore highly beneficial to calibrate the tilt angle directly using the output of the OEIC 106. Additionally, determining the optimal tilt angle directly using the DPD signal, which is already required in the prior art, means that very few (if any) additional hardware components need to be included in the optical disc system.

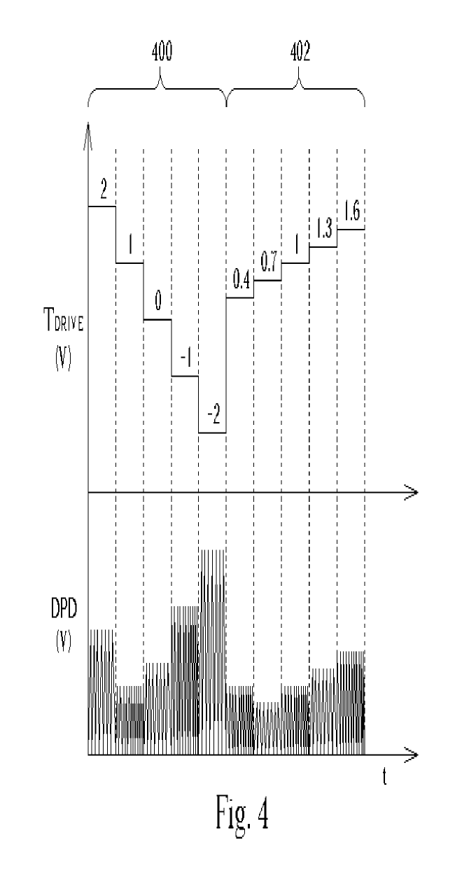

FIG. 4 shows a graph of DPD signal amplitude while searching for the optimal tilt angle using the DPD signal. FIG. 4 includes an example tilt servo control signal T_{DRIVE} and the positive-half of the resulting DPD signal. For illustrative purposes, the example diagram tilt servo control signal T indicates a voltage used to drive the tilt DRIVE servo 112 directly corresponding to the associated tilt angle. In FIG. 4, the tilt angle produced by the tilt servo 112 directly corresponds to the voltage value of the T_{DRIVE} signal. For instance, a T_{DRIVE} value equal to 2V indicates a 2 deg tilt angle, a T_{DRIVE} value equal to 1V indicates a 1 deg tilt angle, etc. This property is for illustrative purposes in this example only and is not a requirement of the present invention. To illustrate a searching process according to the present invention, assume that the ideal tilt angle providing the best detection of the reflected light L is 0.7 deg. To begin calibration, the tilt search block 110 controls the tilt servo 112 to scan a first plurality 400 of five tilt angles starting at 2 deg and having an angle separation of 1 deg. The amplitudes of the DPD signal are compared for each tilt angle in the first plurality 400 of tilt angles and the tilt angle of 1 deg is found to have the lowest amplitude DPD signal. The tilt search block 110 then controls the tilt servo 112 to scan a second plurality 402 of five tilt angles starting at 0.4 deg and having an angle separation of 0.3 deg. The amplitudes of the DPD signal are compared for each tilt angle in the second plurality 402 of tilt angles and, because the tilt angle of 0.7 deg has the lowest amplitude DPD signal, 0.7 deg is used as the tilt angle by the optical disc system.

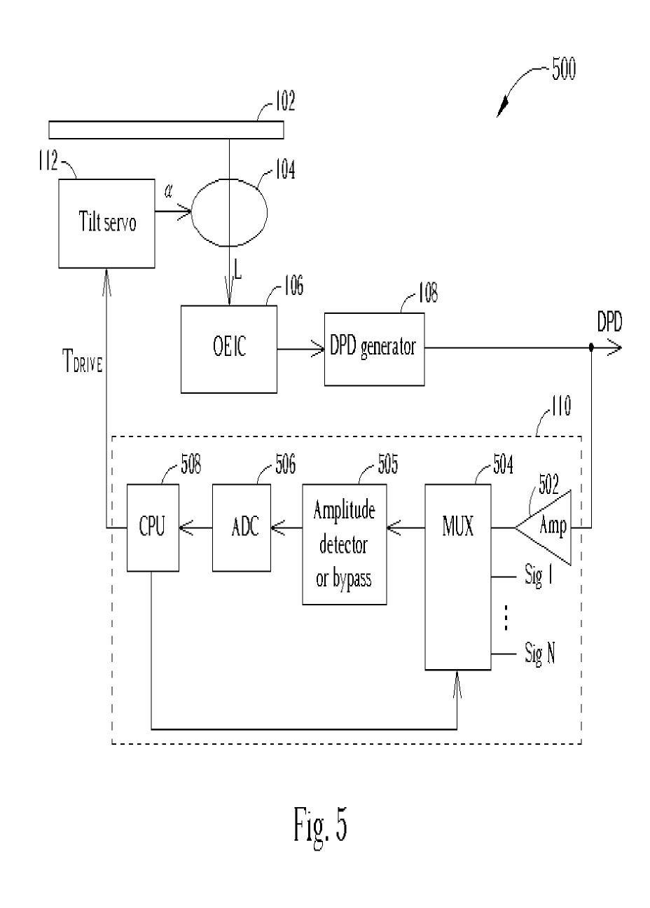

FIG. 5 shows a block diagram of an optical disc system 500 according to the second embodiment of the present invention. The optical disc system 500 according to the second embodiment includes the same basic components connected in the same fashion as the first embodiment shown in FIG. 1. The reflected light L is received by the OEIC 106 and converted to the DPD signal by the DPD signal generator 108 in the same way as the first embodiment shown in FIG. 1. However, in the second embodiment, the tilt search block 110 further comprises an amplifier 502, a multiplexer 504, an amplitude detector 505 (or bypass), an analog to digital converter (ADC) 506, and a central processing unit (CPU) 508. Because the DPD signal is not designed to indicate the tilt angle, it may be required to amplify the signal in order to more easily measure differences between the amplitude of the DPD signal of different tilt angles. The amplifier 502 is provided for this function. The amplitude detector 505 can be used to assist in detecting the amplitude of the amplified DPD signal or if this function is not built-in, block 505 can be bypassed and software executed by the CPU 508 can be used to compute the amplitude. To allow the CPU 508 to search for the optimal tilt angle, the DPD signal needs to be converted to a digital format usable by the CPU. Because most optical disc systems already include an ADC 506, the multiplexer 504 is included to allow the reuse of the already existing ADC 506 to digitize the DPD signal. In some optical disc systems, this multiplexer may itself already exist for allowing the reuse of the ADC converter. FIG. 5 shows an optical disc system having multiple signals (Sig1, . . . , SigN) already being multiplexed by the multiplexer 504 and the DPD signal has been added as one of the signals multiplexed by the multiplexer 504. During tilt angle calibration, the multiplexer 504 is controlled by the CPU 508 to pass the DPD signal to the ADC 506. A digital DPD signal output by the ADC 506 is received by the CPU 508. Using a search algorithm, such as the search algorithm shown in FIG. 4, the CPU 508 scans a plurality of tilt angles to determine the optimal tilt angle having the lowest amplitude DPD signal. When calibration is complete and the optimal tilt angle has been set, the CPU controls the multiplexer 504 to pass the normal-operation signal(s) to the ADC 506.

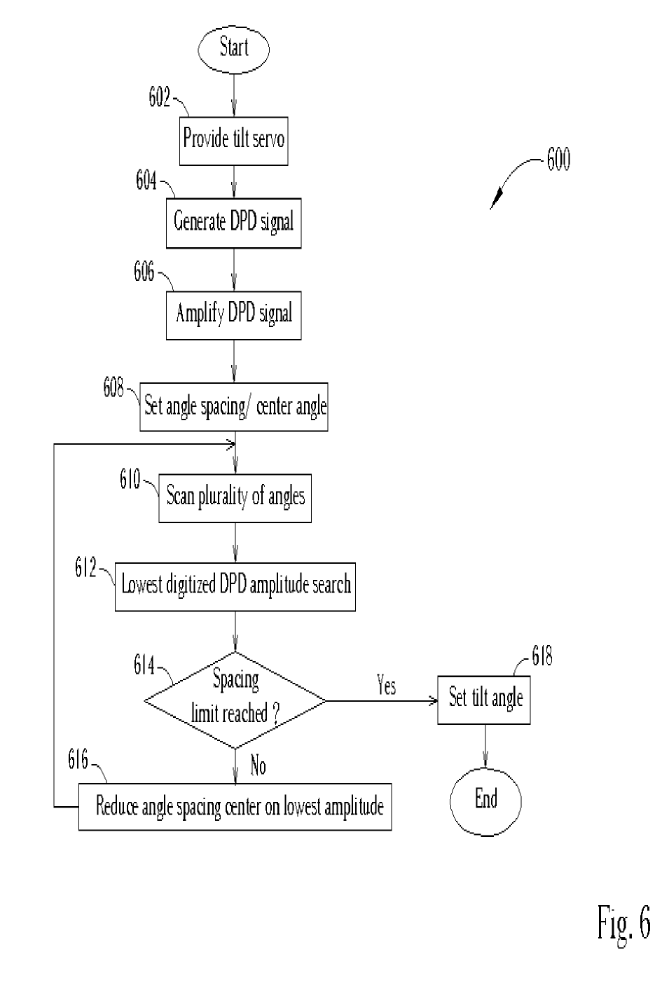

FIG. 6 is a flowchart 600 describing a method of calibrating the tilt angle of an optical disc system according to the present invention. The flowchart 600 includes the following steps:

Step 602: Provide a controllable tilt servo for physically adjusting the tilt angle between the optical disc and an object lens. The tilt servo could be implemented with an actuator driver or another device allowing the relative tilt angle between the optical disc and the object lens to be altered. Proceed to step 604.

Step 604: Generate a differential phase detection (DPD) signal corresponding to the output of an optical electrical integrated circuit (OEIC) as also required in the prior art. Proceed to step 606.

Step 606: Amplify the DPD signal to enhance the differences of amplitudes of DPD signal corresponding to different tilt angles and proceed to step 608.

Step 608: Set a default angle spacing and a default center angle. The angle spacing refers to the angle difference between different angles scanned during tilt angle calibration and the center angle refers to the angle in the center of the plurality of angles. Proceed to step 610.

Step 610: Scan a plurality of tilt angles differing from one another by the angle spacing and centered at the center angle, and simultaneously sample the amplitudes of the DPD signal for computing peak-to-peak amplitudes corresponding to the scanned tilt angles. Proceed to Step 612 .Step 612: Search the plurality of tilt angles scanned in step 612 to determine lowest digitized DPD amplitude. Proceed to step 614.

Step 614: Has an angle spacing limit been reached? If the minimum spacing between tilt angles allowable by the tilt servo has been reached then proceed to step 618, otherwise proceed to step 616.

Step 616: Reduce the angle spacing parameter and set the center angle parameter to the angle having the lowest digitized DPD amplitude determined in step 612. Proceed to step 610 to scan a subset of the plurality tilt angles having lower DPD amplitudes.

Step 618: Set the tilt servo to the tilt angle having the lowest amplitude DPD signal in the plurality of tilt angles scanned in step 614. Tilt angle calibration is finished.

In contrast to the prior art, the present invention uses the DPD signal to calibrate the tilt angle of an optical disc system so that the optimal tilt angle is used resulting in the best signal to noise ratio when recovering data encoded on the optical disc. Because a DPD generator in the prior art already generates the DPD signal, the present invention is a cost effective and efficient solution avoiding the use of extra components such as a tilt sensor or a jitter meter. By iteratively scanning pluralities of tilt angles, each plurality of angles having decreasing angle differences and being centered on a tilt angle having the lowest amplitude DPD signal in the previous plurality, an optimal tilt angle having the lowest amplitude DPD signal can be found.

Those skilled in the art will readily observe that numerous modifications and alterations of the device may be made while retaining the teachings of the invention. Accordingly, the above disclosure should be construed as limited only by the metes and bounds of the appended claims.

1. An optical drive system comprising:
an optical disc;
an object lens for focusing light on the optical disc;
a tilt servo for adjusting a tilt angle between the optical disc and the object lens;
an optical electric integrated circuit (OEIC) for detecting light reflected from the optical disc;
a DPD generator for generating a differential phase detection (DPD) signal according to the output of the OEIC; and
a tilt search block receiving the DPD signal and being connected to the tilt servo, wherein the tilt search block controls the tilt servo to adjust the tilt angle between the optical disc and the object lens according to the DPD signal.

2. The optical drive system of claim 1, wherein the tilt search block further comprises an amplifier for amplifying the DPD signal such that the amplified DPD signal corresponds to a maximum allowable input signal level for the tilt search block, and the tilt search block controls the tilt servo to adjust the tilt angle between the optical disc and the object lens according to the amplified DPD signal.

3. The optical drive system of claim 1, wherein the tilt search block further comprises an analog to digital converter to convert the DPD signal to a digital DPD signal, and the tilt search block controls the tilt servo to adjust the tilt angle between the optical disc and the object lens according to the digital DPD signal.

4. The optical drive system of claim 1, wherein when controlling the tilt servo to adjust the tilt angle between the optical disc and the object lens according to the DPD signal, the tilt search block finds an optimal tilt angle having the lowest amplitude DPD signal.

5. The optical drive system of claim 4, wherein to find the optimal tilt angle having the lowest amplitude DPD signal, the tilt search block controls the tilt servo to adjust the tilt angle to a first plurality of angles, measures the amplitudes of the DPD signals for the first plurality of angles, controls the tilt servo to adjust the tilt angle to a second plurality of angles centered at the angle having the lowest amplitude DPD signal in the first plurality of angles, and measures the amplitudes of the DPD signals for the second plurality of angles to find the optimal tilt angle.

6. The optical drive system of claim 5, wherein the angle spacing between the first plurality of angles is larger than the angle spacing between the second plurality of angles.

7. The optical drive system of claim 4, wherein the tilt search block iteratively scans plurality of angles, each plurality of angles having decreasing angle differences, until an optimal tilt angle having the lowest amplitude DPD signal is found.

8. A method of calibrating the tilt angle between an optical disc and an object lens in an optical storage device, the method comprising the following steps:
(a) providing a tilt servo for adjusting the tilt angle between the optical disc and the object lens;
(b) providing an optical electric integrated circuit (OEIC) for detecting light reflected from the optical disc;
(c) generating a differential phase detection (DPD) signal according to the output of the OEIC; and
(d) controlling the tilt servo to adjust the tilt angle between the optical disc and the object lens according to the DPD signal.

9. The method of claim 8, further comprising amplifying the DPD signal, and controlling the tilt servo to adjust the tilt angle between the optical disc and the object lens according to the amplified DPD signal.

10. The method of claim 8, further comprising converting the DPD signal to a digital DPD signal, and controlling the tilt servo to adjust the tilt angle between the optical disc and the object lens according to the digital DPD signal.

11. The method of claim 8, wherein when controlling the tilt servo to adjust the tilt angle between the optical disc and the object lens according to the DPD signal, finding an optimal tilt angle having the lowest amplitude DPD signal.

12. The method of claim 11, wherein finding the optimal tilt angle having the lowest amplitude DPD signal comprises controlling the tilt servo to adjust the tilt angle to a first plurality of angles, measuring the amplitudes of the DPD signals for the first plurality of angles, controlling the tilt servo to adjust the tilt angle to a second plurality of angles centered at the angle having the lowest amplitude DPD signal in the first plurality of angles, and measuring the amplitudes of the DPD signals for the second plurality of angles to find the optimal tilt angle.

13. The method of claim 12, wherein the angle spacing between the first plurality of angles is larger than the angle spacing between the second plurality of angles.

14. The method of claim 13, wherein finding the optimal tilt angle having the lowest amplitude DPD signal comprises iteratively scanning a plurality of angles having decreasing angle differences until an optimal tilt angle having the lowest amplitude DPD signal is found.
